(19) United States
(12) Patent Application Publication
(10) Pub. No.: US 2008/0244555 A1
(43) Pub. Date: Oct. 2, 2008

(54) Bundling software updates

(76) Inventors: Eugene F. Welvaert, East Peoria, IL (US); John W. Schalk, Bloomington, IL (US); William D. Donlan, Peoria, IL (US); Kathleen S. Hurst, Bartonville, IL (US); Janice L. Setterlund, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/730,082

(22) Filed: Mar. 29, 2007

(51) Int. Cl. G06F 9/44

(52) U.S. Cl. 717/169

(57) ABSTRACT

In one implementation, a method is provided for bundling software updates for an enterprise. According to the method, the software updates are received, stored in a database, and associated with the bundle. At one or more predetermined checkpoints, the method checks for additional software updates and, if additional software updates are available, receives the additional software updates and associates the additional software updates with the bundle. The method further comprises freezing contents of the bundle at a predetermined bundle content freeze point. After the bundle content freeze point, additional software updates are not associated with the bundle.

### TECHNICAL FIELD

The present disclosure relates generally to software updates, and more particularly, to a system and computer-implemented method for bundling software updates for an enterprise.

### BACKGROUND

Software is a prevalent and pervasive aspect of modern enterprises, such as businesses. A typical enterprise might use a variety of different types of software. Some of the software might be from commercial vendors. For example, a business might obtain software from a vendor in order to provide tools to its employees for performing general office tasks, such as word processing and e-mail communication. The business might also obtain software from a vendor to perform specialized functions, such as, for example, engineering design software, accounting software, and supply chain management software. On the other hand, the enterprise might employ software engineers who write software that is used internally by the enterprise. Developers might, for example, design specific tools that are used by other employees in the enterprise, such as software for managing customer accounts. As still yet another category of software, the enterprise's internal developers might also write software that customizes vendor software so that it meets specific requirements of the enterprise.

During the course of any given time period, software used by an enterprise might require updates for a number of reasons. The vendors from whom the enterprise purchased the software might make updates available to provide new functionality or to address bugs in the original software. Other updates may originate from the developers that are employed by the enterprise, such as updates to internal software and/or updates to customized software. Typically, when updates become available, enterprises do not coordinate the distribution of the updates to its servers and/or workstations of its employees. Administrators and employees may update the software as the updates become available and on their own timetable. That is, the updates occur on an ad hoc basis. However, due to compatibility issues between existing versions of software, the software updates, and any interactions that may be caused by the software updates, can cause disruptions to the enterprise. For example, some enterprises continue to use legacy software. Often, modern software does not take into consideration the effects it may have on legacy software. Accordingly, the software updates can cause unintended compatibility problems. In some situations, a user that has updated a software tool may send a file to a colleague that has not yet updated his or her version of the software tool. As a result, the colleague may not be able to access the file. Furthermore, internal software and internal customization of vendor software may also suffer from compatibility problems due to vendor and/or internal software updates. Disruptions to the enterprise result in inefficiencies because time is lost when resources are diverted to address compatibility issues, which, in turn, increases costs for the enterprise.

The disclosed embodiments are directed to overcoming one or more of the problems set forth above.

### SUMMARY OF THE INVENTION

In one aspect, the present disclosure is directed to a method for bundling software updates for an enterprise. The method may receive the software updates, store the software updates in a database, and associate the software updates with a bundle. The method may further check at one or more predetermined checkpoints for additional software updates. If additional software updates are available, the method may receive the additional software updates and associate the additional software updates with the bundle. Furthermore, the method may freeze the contents of the bundle at a predetermined bundle content freeze point. After the bundle content freeze point, the method may not associate additional software updates with the bundle.

In another aspect, the present disclosure is directed to a computer-readable medium storing program instructions for executing the above described method.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments. In the drawings:

FIG. 1 is an example of a system for bundling, testing, and distributing software updates for an enterprise;

FIG. 2 is an example of a timeline for bundling, testing, and distributing software updates for an enterprise;

FIG. 3 is an example of a software architecture for bundling, testing, and distributing software updates for an enterprise; and

FIG. 4 is a flow diagram of an example of a method for bundling, testing, and distributing software updates for an enterprise.

### DETAILED DESCRIPTION

Reference will now be made in detail to the following exemplary embodiments, which are illustrated in the accompanying drawings. Wherever possible, the same reference numbers will be used throughout the drawings to refer to the same or like parts.

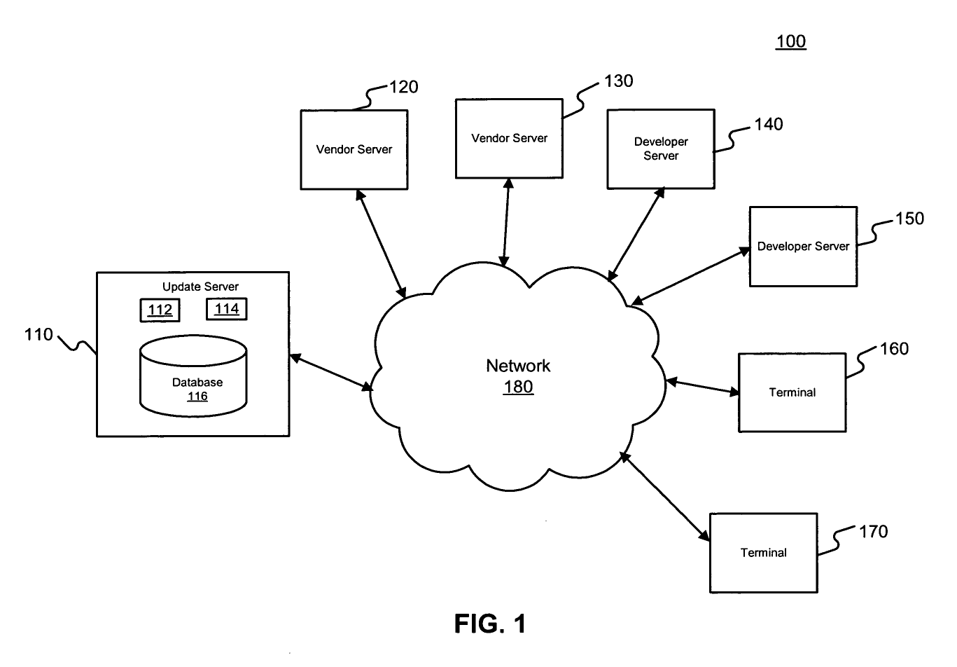

FIG. 1 is an example of a system 100 for bundling, testing, and distributing software updates for an enterprise. In particular, system 100 may include functionality for receiving, bundling, testing, and distributing software updates that are received from one or more systems. As shown in system 100, update server 110, vendor servers 120 and 130, developer servers 140 and 150, and terminals 160 and 170 are connected to a network 180. One of skill in the art will appreciate that although one update server, two vendor servers, two developer servers, and two terminals are depicted in FIG. 1, any number of these entities may be provided. Furthermore, one of ordinary skill in the art will recognize that functions provided by one or more entities of system 100 may be combined.

Network 180 provides communications between the various entities in system 100, such as update server 110, vendor servers 120-130, developer servers 140-150, and terminals 160-170. In addition, update server 110, vendor servers 120-130, developer servers 140-150, and terminals 160-170 may access legacy systems (not shown) via network 180, or may directly access legacy systems, databases, or other network applications. Network 180 may be a shared, public, or private network, may encompass a wide area or local area, and may be implemented through any suitable combination of wired and/or wireless communication networks. Furthermore, network 180 may comprise a local area network (LAN), a wide area network (WAN), an intranet, or the Internet.

Update server 110 may comprise a general purpose computer (e.g., a personal computer, network computer, server, or mainframe computer) having a processor 112 that may be selectively activated or reconfigured by a computer program. Update server 110 may also be implemented in a distributed network. For example, update server 110 may communicate via network 180 with one or more additional update servers (not shown), which may enable update server 110 to distribute a process for parallel execution by a plurality of update servers. Alternatively, update server 110 may be specially constructed for carrying-out methods consistent with disclosed embodiments.

Update server 110 may further include a memory 114 for storing program modules that, when executed by processor 112, perform one or more processes for receiving, bundling, testing, and distributing software updates in a bundle. Memory 114 may be one or more memory devices that store data as well as software. Memory 114 may also comprise one or more of RAM, ROM, magnetic storage, or optical storage, for example.

Update server 110 may receive data, such as software updates, from one or more systems and store the received data in database 116. Furthermore, update server 110 may check for software updates on a periodic basis, such as hourly, daily, weekly, monthly, etc. These checks may occur at predetermined “checkpoints.” For example, an administrator of update server 110 may set the checkpoint at desired intervals. Update server 110 may further enforce a bundle content freeze point. The bundle content freeze point freezes a bundle so that any new updates after the freeze point are not included in the bundle. After reaching a bundle freeze point, no further updates may be included in the bundle. Developers may continue to complete coding of bundles that have been designated for the bundle prior to the freeze point. Update server 110 may also enforce a functionality freeze point after which developers may not introduce new functionality into updates. Still further, update server 110 may enforce a bundle code freeze point. After the bundle code freeze point, developers may not make any changes in the code that is going to be included in the bundle. Furthermore, in at least one disclosed embodiment, exception processing may allow certain updates to be included in a bundle after a freeze point. Exception processing is discussed below in further detail.

Update server 110 may further provide functionality for establishing one or more testing environments for a bundle. For example, update server 110 may provide an alpha testing environment for testing software updates that are a part of the bundle individually with existing software. Update server 110 may further provide a beta testing environment for testing software updates that are a part of the bundle for compatibility with each other. Still further, update server 110 may provide a preproduction testing environment for user acceptance testing of the bundle. Although any of the aforementioned testing environments may be provided by update server 110, in other embodiments, the testing environments may be provided on any appropriate server and/or terminal. In such an embodiment, update server 110 may distribute the software necessary to conduct the test via network 180.

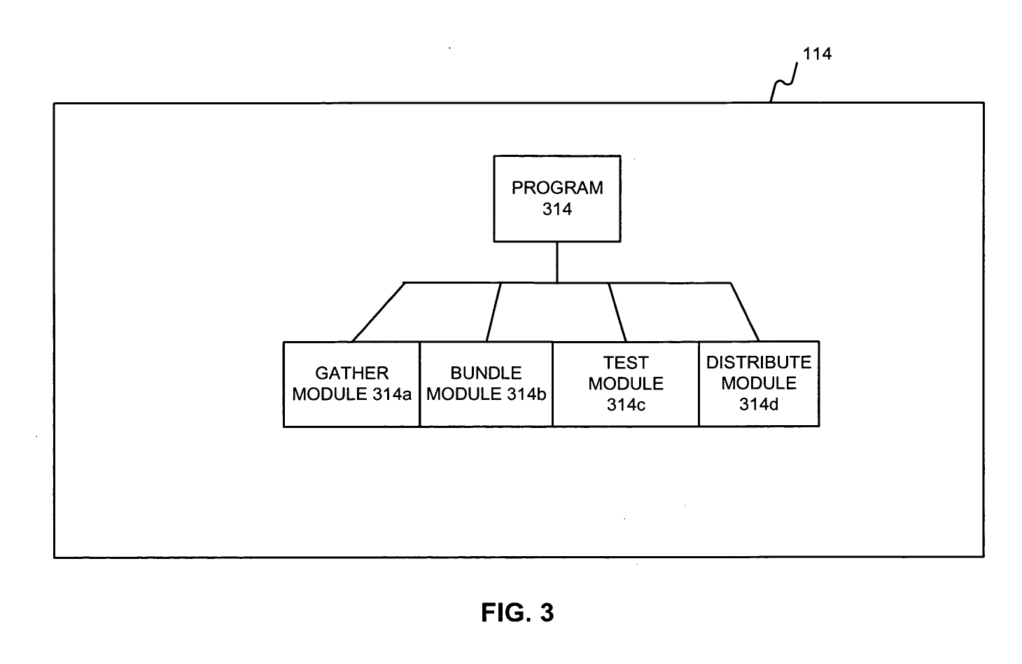

Subsequent to user acceptance testing, update server 110 may distribute the bundle to one location or unit of the enterprise for a pilot test. After testing and/or when determined by an administrator, for example, update server 110 may provide functionality for rolling out the updates to one or more units of an enterprise. Update server 110 may further provide functionality for configuring updates that have been rolled out. Functionality provided by update server 110 may be stored as one or more program modules in memory 114 of update server 110 and is discussed in further detail with respect to FIG. 3.

Vendor servers 120-130 and developer servers 140-150 may comprise general purpose computers (e.g., a personal computer, network computer, server, or mainframe computer) and include databases (not shown) for storing data, such as software updates. For example, vendor servers 120-130 provide updates for software provided by commercial software vendors and developer servers 150-160 may provide updates for commercial software, customized software, and/or software developed internally by the enterprise.

Terminals 160-170 may be any type device for communicating with update server 110, vendor servers 120-130, and/or developer servers 140-150, over network 180. For example, terminals 160-170 may be personal computers, handheld devices, or any other appropriate computing platform or device capable of exchanging data with network 180. Terminals 160-170 may each include a processor and a memory (not shown), for example. Further, terminals 160-170 may execute program modules that provide one or more graphical user interfaces (GUIs) for interacting with network resources, such as update server 110.

Users may access update server 110 over network 180 through a web browser or software application running on any one of terminals 160-170. For example, a web portal may include options for allowing a user, such as an administrator, to log onto a secure site provided by update server 110 by supplying credentials, such as a username and a password. Once logged onto the site, the web portal may display a series of screens prompting the user to make various selections to execute an update and configuration tool.

In operation, the update and configuration tool may provide functionality for configuring and delivering software updates to one or more units of an enterprise. The updates may be delivered according to a predetermined schedule. For example, in one embodiment, bundled updates may be delivered on a semi-annual basis. However, one of ordinary skill in the art will appreciate that any other appropriate time period (e.g., monthly, quarterly, annually, etc.) for delivery of updates may be implemented. Further, the update and configuration tool may be implemented in a secure fashion using an HTTPS (hypertext transfer protocol secure) environment to transfer data over a network.

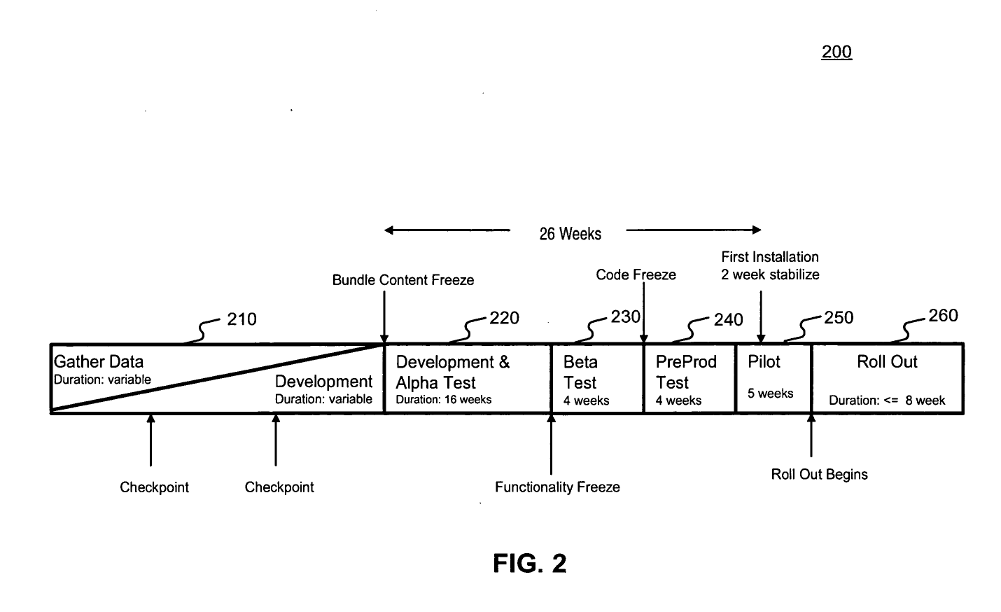

FIG. 2 is an example of a timeline 200 for bundling, testing, and distributing software updates for an enterprise. Timeline 200 provides an example of a sequence of phases for a bundle lifecycle. The bundle lifecycle shown represents a business process that maximizes information technology (IT) value, stabilizes resources, and minimizes changes to an enterprise. Although timeline 200 provides various time periods in association with the depicted phases, one of ordinary skill in the art will appreciate that modifications to the specified time periods are contemplated and that timeline 200 is provided as an example.

As shown, gather data and development phase 210 may start the bundle lifecycle. At the start of the bundle lifecycle, data (e.g., software updates) may be gathered from external sources, such as vendor servers 120-130, and from internal sources, such as developer servers 140-150. During gather data and development phase 210, two checkpoints are shown for determining software readiness and whether or not there are additional updates to include in the bundle. One of skill in the art will appreciate that the number and occurrence of the checkpoints may vary from enterprise to enterprise.

At the conclusion of gather data and development phase 210, content for the bundle may be frozen. That is, at bundle content freeze point, no further software updates are accepted (unless meeting certain exception processing conditions, discussed below) for the bundle. Accordingly, any subsequent software updates are held until the next bundle is distributed.

Development and alpha test phase 220 provides developers with the opportunity to test and continue to code any internal software, including software updates and/or customized software, identified during gather data and development phase 210. Furthermore, any software updates gathered from external sources, such as vendor servers 120-130, may be tested for compatibility with existing software used by an enterprise. For example, during development and alpha test phase 220, programmers may test software updates that are a part of the bundle individually with existing software used by the enterprise. At the conclusion of development and alpha test phase 220, functionality to be included in the bundle may be frozen. That is, developers may not add any further planned functionality to their software. Any issues determined during development and alpha test phase 220 may be transmitted to update server 110. For example, update server 110 may provide functionality for issue tracking and store records relating to open issues in database 116.

In beta test phase 230, programmers may test software updates that are a part of the bundle for compatibility with each other. At the conclusion of beta test phase 230, a code freeze point may be reached and no further changes may be made to the code. That is, after beta test phase 230, developers may not modify or add to any code intended for inclusion in the bundle. Any issues determined during beta test phase 230 may be transmitted to update server 110. For example, update server 110 may store records relating to open issues in database 116.

Beta test phase 230 may be followed by a preproduction test phase 240, which may allow for user acceptance testing of the bundle. During user acceptance testing, typically a small group of testers that are intended users of the updated software products use the software. Acceptance testing users may submit any identified issues to update server 110.

Subsequent to user acceptance testing, pilot phase 250 may allow a location or unit of the enterprise to install and test the updates. Users at the pilot location may submit any identified issues to update server 110. Once pilot phase 250 is complete and identified issues are resolved and/or sufficiently addressed, the testing is considered complete and the bundle ready for distribution to the enterprise.

During roll out phase 260, update server 110 may distribute the updates to one or more units of the enterprise. For example, update server 110 may distribute a script to administrators, which they may then execute to install the updated software. Furthermore, the script may trigger a configuration wizard, which may allow the administrator to configure certain aspects of the updated software.

FIG. 3 is an example of a software architecture for bundling, testing, and distributing software updates for an enterprise. The software architecture may be stored in memory 114 of update server 110, as shown in FIG. 1, for example. In other embodiments, the software architecture may be stored in, for example, any one of terminals 160-170.

In one embodiment, memory 114 may store instructions of program 314, which when executed, perform one or more data processes for bundling, testing, and distributing software updates. To do so, program 314 may include instructions in the form of one or more program modules 314a-314d. Program modules 314a-314d may be written using any known programming language, such as C++, XML, etc., and may include a gather module 314a, a bundle module 314b, a testing module 314c, and a distribute module 314d.

Gather module 314a may receive data, such as software updates, from one or more systems and store the data in database 116. To do so, gather module 314a may check vendor servers 120-130 and/or developer servers 140-150 for software updates on a periodic basis. For example, gather module 314a may check for updates hourly, daily, weekly, monthly, etc. For example, gather module 314a may examine version numbers of updates being hosted by vendor servers 120-130. If gather module 314a detects new version numbers for the hosted updates, gather module 314a may retrieve the updates. Furthermore, gather module 314a may store the updates in database 116 and designate that the updates are for inclusion in a particular bundle. For example, each update may be associated with a unique bundler version number (e.g., bundle 2A). Gather module 314a may also retrieve any updates stored on developer servers 140-150. If the updates have not been completed (i.e., the developers expect to have the updates completed, but are still coding), gather module 314a may store in database 116 a record indication that developer servers 140-150 should be checked at appropriate checkpoints. Furthermore, gather module 314a may store identifiers of certain software updates that developers continue to develop. For example, an identifier may indicate a storage location accessible via network 180 from which a particular update may be retrieved. In some circumstances, gather bundle 314a may determine that a particular update should not be included in a bundle for any number of reasons (e.g., determined by employees of the enterprise to be unnecessary or not ready for inclusion in the bundle), and that update may not be associated with the bundle.

Bundle module 314b may enforce one or more checkpoints that freeze a bundle to any new updates. A bundle content freeze point may freeze a bundle so that any new updates after the freeze point are not included in the bundle. After reaching a bundle freeze point, no further updates may be included in the bundle. Developers may continue to complete coding of bundles that have been designated for the bundle prior to the free point. After a functionality freeze point, developers may not introduce new functionality into updates. After a bundle code freeze point, developers may not make any changes in the code that is going to be included in the bundle.

However, bundle module 314b may also provide exception processing in certain circumstances in order to allow an update to be added to a frozen bundle. For example, bundle module 314b may grant an exception to include a change in a bundle when the change to the software is needed to fix a “bug” or to add functionality or capabilities to current production. In other circumstances, such as an urgent (or emergency change), bundle module 314b may automatically allow the change after any one or more of the above discussed freeze points have been reached. A user may submit such an exception request, which may be resolved by an administrator, for example, of update server 110.

Furthermore, at any freeze or distribution point in which the bundle is needed, bundle module 314b may retrieve from database 116 the software updates that are included in the bundle. In addition, bundle module 314b may retrieve any software updates that are not stored in database 116 using an identifier. The identifier may indicate a storage location accessible via network 180 from which the update may be retrieved.

Bundle module 314b may provide any necessary code for installing the bundle, such as a script. For example, bundle module 314b may package a bundle for distribution. Packaging the bundle may include application of any necessary data compression techniques to minimize the amount of data included in the bundle. Furthermore, bundle module 314b may generate an appropriate script for installing (including any extraction functionality necessary to expand compressed data) and configuring the bundle.

Testing module 314c may provide functionality for establishing one or more testing environments for a bundle. For example, testing module 314c may establish one or more testing environments in update server 110, another server (e.g., developer servers 140-150), or terminals 160-170. Furthermore, testing module 314c may include one or more sub-modules (not shown) that distribute updates for an alpha test, a beta test, a preproduction test, and a pilot test. For example, testing module 314c may provide an alpha testing environment for testing software updates that are a part of the bundle individually with existing software. Testing module 314c may further provide a beta testing environment for testing software updates that are a part of the bundle for compatibility with each other. Still further, testing module 314c may provide a preproduction testing environment for user acceptance testing of the bundle. Subsequent to user acceptance testing, testing module 314c may distribute the bundle to one location or unit of the enterprise for a pilot test.

Testing module 314c may further include functionality for receiving reports of issues identified during the testing process. For example, testing module 314c may provide a user interface for submitting identified issues from terminals 160-170, for example. Furthermore, testing module 314c may provide messaging functionality in order to notify appropriate individuals of identified issues so that the issues may be resolved.

Distribute module 314d may provide functionality for distributing the final updates to one or more units of an enterprise. For example, at a predetermined roll out date, distribute module 314d may transmit the bundle to a client. Alternatively, distribute module 314d may transmit a script to the client. An administrator at the client may execute the script, which may then retrieve the bundle components sent from update server 110 and install the bundle. Furthermore, the script may further provide functionality for configuring updates that have been rolled out. For example, when an administrator at a client executes a script for a bundle, the script may allow the administrator to select certain features for installation. However, for certain features, the administrator may be required to install portions of the update for compatibility purposes.

Although program modules 314a-314d have been described above as being separate modules, one of ordinary skill in the art will recognize that functionalities provided by one or more modules may be combined.

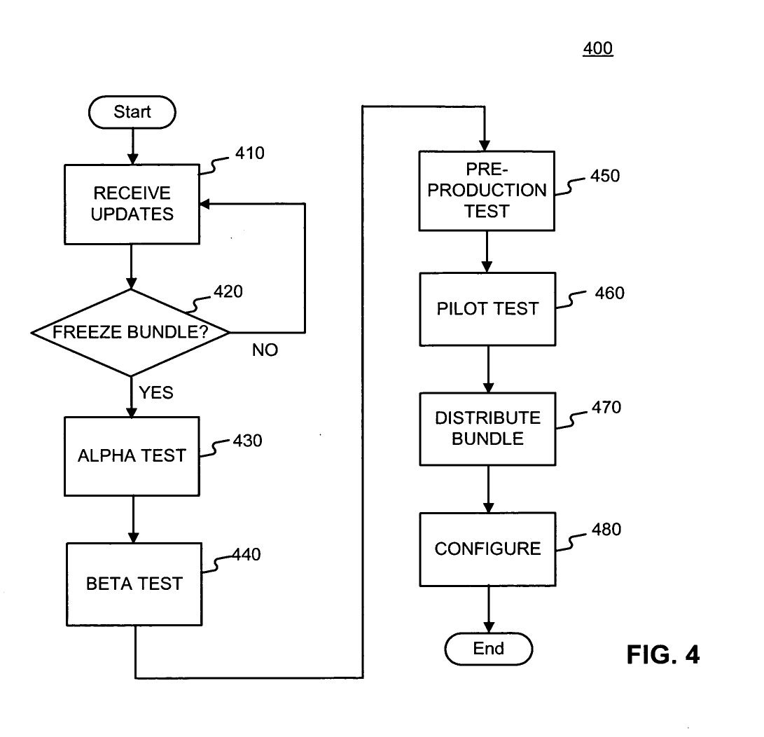

Referring now to FIG. 4, a flow diagram 400 is provided of an example of a method for bundling, testing, and distributing software updates for an enterprise. For example, the method may implement processes according to one or more of program modules 314a-314d.

At the start of the process, in step 410, gather module 314a may receive data, such as software updates, from one or more systems and store the data in database 116. As discussed above, update server 110 may check for software updates at one or more predetermined checkpoints. Furthermore, gather module 314a may receive identifiers of software updates which developers plan to include in the bundle, but which may require additional time to code. Contents of a particular bundle may be associated with a version number, for example. The process proceeds to step 420.

Next, in step 420, bundle module 314b may check whether or not the bundle content should be frozen based on readiness or compatibility with other bundle content. If so, no further updates may be included in the bundle and the process proceeds to step 430. If not, the process returns to step 410 and additional updates may be accepted for inclusion in the bundle.

In step 430, an alpha test may be conducted. For example, testing module 314c may provide an alpha testing environment for testing software updates that are a part of the bundle individually with existing software. Alternatively, testing module 314c may distribute the software updates to a different testing environment. Testing module 314c may further receive identified issue reports from testers. At the conclusion of the alpha test phase, bundle module 314b may freeze functionality that may be included in the software updates. The process proceeds to step 440.

In step 440, a beta test may be conducted. Testing module 314c may provide a beta testing environment for testing software updates that are a part of the bundle for compatibility with each other. Alternatively, testing module 314c may distribute the software updates to a different testing environment. Testing module 314c may further receive identified issue reports from testers. At the conclusion of the alpha test phase, bundle module 314b may freeze the code. That is, after a code freeze point, no changes to the code included in the bundle may be made. The process proceeds to step 450.

Next, in step 450, a preproduction test may be conducted. Testing module 314c may provide a preproduction testing environment for user acceptance testing of the bundle. For example, testing module 314c may distribute the software updates to particular user terminals. Testing module 314c may further receive identified issue reports from testers. The process proceeds to step 460.

In step 460, a pilot test may be conducted. For example, testing module 314c may distribute the bundle to one location or unit of the enterprise for a pilot test. Testing module 314c may further receive identified issue reports from testers. The process proceeds to step 470.

Next, in step 470, distribute module 314d may transmit a finalize bundle to one or more units of an enterprise. For example, at a predetermined roll out date, distribute module 314d may transmit the bundle to one or more clients. Alternatively, distribute module 314d may transmit a script to the one or more clients. An administrator at the client may execute the script, which may then retrieve the bundle from update server 110 and install the bundle. The process proceeds to step 480.

Next, in step 480, the script may further provide functionality for configuring updates that have been rolled out. For example, when an administrator at a client executes a script for a bundle, the script may allow the administrator to select certain features for installation. However, for compatibility purposes, certain aspects of the software update may be required and may not be optional. Accordingly, in one disclosed embodiment, the ability to configure updates may be limited to features that are specific to a particular unit of the enterprise and/or do not pose compatibility issues. The process then ends.

As one of ordinary skill in the art will appreciate, one or more of steps 410-480 may be optional and may be omitted from implementations in certain embodiments.

### INDUSTRIAL APPLICABILITY

Disclosed embodiments provide functionality for receiving software updates from a plurality of systems, including vendor systems and developer systems. Disclosed embodiments may check for software updates on a periodic basis. For example, these checks may occur at predetermined checkpoints and an update server may, at a predetermined time, enforce one or more freeze points. The freeze points may include a content freeze point, a functionality freeze point, and a code freeze point. The update server may further facilitate the testing, distributing, and configuration of the bundle at one or more client sites.

Accordingly, disclosed systems and methods bundle software updates received from vendors and internal developers. As a result, an enterprise may efficiently plan for and distribute the updates in a controlled manner in order to avoid compatibility issues. Furthermore, the systems and methods collect updates from vendors and developers according to a scheduled process that maximizes information technology (IT) value, stabilizes resources, and minimizes changes to an enterprise.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments. For example, the described implementations include software, but systems and methods consistent with the present invention may be implemented as a combination of hardware and software or in hardware alone. Examples of hardware include computing or processing systems, including personal computers, servers, laptops, mainframes, microprocessors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A method for bundling software updates for an enterprise, the method comprising:
receiving the software updates;
storing the software updates in a database, wherein the software updates are associated with a bundle;
checking at one or more predetermined checkpoints for additional software updates and, if additional software updates are available, receiving the additional software updates and associating the additional software updates with the bundle; and
freezing the contents of the bundle at a predetermined bundle content freeze point, wherein after the bundle content freeze point, additional software updates are not associated with the bundle.

2. The method of claim 1, wherein the software updates are received from one or more vendor servers and one or more developer servers.

3. The method of claim 1, wherein the software updates are received from at least two unrelated entities.

4. The method of claim 1, wherein the software updates are associated with the bundle by a version number.

5. The method of claim 1, further comprising:
distributing the contents of the bundle to a testing environment for a test phase in which the contents of the bundle are tested individually.

6. The method of 5, wherein the software updates are received from one or more developer servers, the method further comprising:
adding functionality to the software updates received from the one or more developer servers until a functionality freeze point, wherein the functionality freeze point occurs after the test phase has been completed.

7. The method of claim 1, further comprising:
distributing the bundle to a testing environment for a test phase in which the bundle is tested for compatibility with at least two software programs that are used by the enterprise.

8. The method of claim 7, wherein the software updates are received from one or more developer servers, the method further comprising:
modifying code of the software updates received from the one or more developer servers until a code freeze point, wherein the code freeze point occurs after the test phase has been completed.

9. The method of claim 1, further comprising:
transmitting a script to a plurality of clients, the script providing executable code for installing the bundle; and
causing the plurality of clients to execute the script.

10. A computer-readable medium storing instructions executable by a processor for bundling software updates for an enterprise according to a method, the method comprising:
receiving the software updates;
storing the software updates in a database, wherein the software updates are associated with the bundle;
checking at one or more predetermined checkpoints for additional software updates and, if additional software updates are available, receiving the additional software updates and associating the additional software updates with the bundle; and
freezing the contents of the bundle at a predetermined bundle content freeze point, wherein after the bundle content freeze point, additional software updates are not associated with the bundle.

11. The computer-readable medium of claim 10, wherein the software updates are received from one or more vendor servers and one or more developer servers.

12. The computer-readable medium of claim 10, wherein the software updates are received from at least two unrelated entities.

13. The computer-readable medium of claim 10, wherein the software updates are associated with the bundle by a version number.

14. The computer-readable medium of claim 10, the method further comprising:
distributing the contents of the bundle to a testing environment for a test phase in which the contents of the bundle are tested individually.

15. The computer-readable medium of 14, wherein the software updates are received from one or more developer servers, the method further comprising:
adding functionality to the software updates received from the one or more developer servers until a functionality freeze point, wherein the functionality freeze point occurs after the test phase has been completed.

16. The computer-readable medium of claim 10, the method further comprising:
distributing the bundle to a testing environment for a test phase in which the bundle is tested for compatibility with at least two software programs that are used by the enterprise.

17. The computer-readable medium of claim 16, wherein the software updates are received from one or more developer servers, the method further comprising:
modifying code of the software updates received from the one or more developer servers until a code freeze point, wherein the code freeze point occurs after the test phase has been completed.

18. The computer-readable medium of claim 10, the method further comprising:
transmitting a script to a plurality of clients, the script providing executable code for installing the bundle; and
causing the plurality of clients to execute the script.

19. A method for bundling software updates for an enterprise, the method comprising:
receiving the software updates;
storing the software updates in a database, wherein the software updates are associated with a bundle;
checking at one or more predetermined checkpoints for additional software updates and, if additional software updates are available, receiving the additional software updates and associating the additional software updates with the bundle;
freezing the contents of the bundle at a predetermined bundle content freeze point, wherein after the bundle content freeze point, additional software updates are not associated with the bundle; and
prior to releasing the bundle for installation, testing the contents of the bundle for compatibility with at least two software programs.

20. The method of claim 19, wherein the software updates are received from one or more vendor servers and one or more developer servers.
